(19) United States
(12) Patent Application Publication
(10) Pub. No.: US 2010/0035225 A1
(43) Pub. Date: Feb. 11, 2010

(54) ADAPTIVE SPACED TEACHING METHOD AND SYSTEM

(75) Inventor: Branch Price Kerfoot, III, Sherborn, MA (US)

Correspondence Address: DAVID S. RESNICK, NIXON PEABODY LLP, 100 SUMMER STREET, BOSTON, MA, 02110-2131, US

(73) Assignee: PRESIDENT AND FELLOWS OF HARVARD COLLEGE, Cambridge, MA (US)

(21) Appl. No.: 12/307,769

(22) PCT Filed: Jul. 11, 2007
(86) PCT No.: PCT/US07/15779

§ 371 Date: Oct. 20, 2009

Related U.S. Application Data
(60) Provisional application No. 60/830,156, filed on Jul. 11, 2006.

(51) Int. Cl. G09B 7/00

(52) U.S. Cl. 434/335; 434/362

(57) ABSTRACT

The system of the present invention provides interactive spaced education and combines the pedagogical merits of the spacing effect and the testing effect to improve a learner's ability to learn and retain conceptual items. A test item, such as a question or educational material regarding a concept, is delivered, a learner's response is recorded, and the correct answer to the test item is provided. Future delivery of additional test items is customized with regard to its content, difficulty, and time interval based on information from the learner's response(s). The electronic delivery includes a structured repetition over spaced intervals of time as well as retesting the learner with subsequent test items based on new levels of difficulty, new delivery intervals, and new content areas. The present invention, by combining spaced education with adaptive learning, improves the learner's ability to learn, recall, and retain items of information.

The present invention arose from research sponsored by the U.S. Department of Veterans Affairs. The United States Government has certain rights in this invention.

### FIELD OF THE INVENTION

The present invention relates to learning methodologies and styles to facilitate long-term learning. More particularly, the present invention relates to an interactive system and method of adaptive spaced teaching.

### BACKGROUND OF THE INVENTION

Medical knowledge learned by trainees is often quickly forgotten. This is not unexpected, since forgetting is a natural psychological phenomenon. As early as work by Ebbinghaus published in 1885, forgetting curves (plots of memory retention over time) have been established for different types of memories, ranging from pictures of faces to names learned at a cocktail party. Ebbinghaus learned sequences of non-sense letter combinations, only to find that he repeatedly forgot more than 40% in under 5 minutes (Baddeley, A. (2004). Your Memory: A User's Guide; Ebbinghaus, H. (1964). Memory: A Contribution to Experimental Psychology), original German text published in 1885. Memory of medical knowledge and skills is prey to these same processes of forgetting. For example, a study of retention of cardiopulmonary resuscitation (C PR) skills demonstrated a rapid, linear and substantial decay in skill in the year following training. In fact, only 2.4% of those trained 3 years earlier could successfully perform CPR. (McKenna S. P. and Glendon, A I, (1985). Occupational first aid training: decay in cardiopulmonary resuscitation (CPR) skills. J. Occup. Psychol. 58:109-17).

One primary goal of medical education and of education in general, is to generate long-term learning, not just memories which quickly decay after a given lecture, conference, or test. This raises the important question as to how the educational process itself might be tailored to shift learning into longer-term memory.

“Spaced Education” refers to educational programs, which are constructed to take advantage of the pedagogical merits of both the “spacing effect” and the “testing effect”. Elucidated via psychological research in the 1970s and 1980s, the “spacing effect” refers to the finding that educational encounters which are spaced and repeated over time (i.e., “spaced distribution”) result in more efficient learning and improved learning retention, compared to massed distribution of the educational encounters (termed “bolus education”) (Glenberg, A. M., Lehmann, T. S. (1980). Spacing repetitions over 1 week. Memory & Cognition. 8(6):528-38; Toppino, T. C., et al. (1991). The effect of spacing repetitions on the recognition memory of young children and adults. J. Exp. Child Psychol. 51(1):123-38).

The “testing effect”, on the other hand, refers to the psychological finding that initial testing of learned material does not serve merely to evaluate students' performance, but actually alters the learning process itself to significantly improve retention (Spitzer, H. F. (1939). Studies in retention. Journal of Experimental Psychology. 30(9):641-56). The impact of the testing effect has been demonstrated in a study of 120 college students. Those students who studied a prose passage for 7 minutes and then were immediately tested on the passage over 7 minutes had significantly better retention of the material one week later, compared to those students who spent the same total amount of time, 14 minutes, studying the prose in the absence of testing (Roediger, H. L., and J. D. Karpicke. (2006). Test-enhanced learning: taking memory tests improves long-term retention. Psychol. Sci. 17(3):249-55).

Efforts to date to improve the pace at which students learn, to improve retention times, and to facilitate greater understanding of the subject matter at hand have not successfully incorporated the spacing effect and testing effect in a manner that may be customized or adjusted for use by different students under a variety of conditions. The need exists for a teaching system that utilizes spaced education and is adaptive to the needs of the user.

### SUMMARY OF THE INVENTION

The present invention provides a method and system of spaced education for improving a learner's ability to learn and retain one or more items of information, including concepts, principles, facts, methods, plans, and the like. The system and method of the present invention includes delivering a test item, recording a learner's interaction with the test item, providing the learner with the correct answer to the test item, and customizing the future delivery of a test item. The delivery of a test item to the learner may include a question or an educational material, or the like regarding a concept. Learners may include students, on-line users, chat room participants, and the like. The test item may be delivered via electronic media such as an email, a facsimile, a posting, a chat room discussion, and the like. The delivery includes a structured repetition over spaced intervals of time, that is, “spaced education.” The system and method of the present invention electronically records the learner's interaction with the test item, for example, the learner's answers to questions or responses to the educational materials, or the like. The system and method of the present invention provides the learner with the correct answers to the test items and to the educational materials to foster learning about the pertinent concepts. Future delivery of a test item (e.g., questions and/or educational material) is customized for each learner with regard to its content, difficulty, and time interval of delivery based on information from the learner's prior interaction(s) (e.g., their response(s) to the question(s). The present invention, by combining spaced education with adaptive learning, improves the learner's ability to learn, recall, and retain items of information.

In one aspect, the invention comprises testing a learner's understanding of a concept or concepts by electronically delivering to the learner one or more test items (e.g., questions and/or educational material) related to the concept or concepts. The electronic deliveries are spaced over intervals of time. The system of the present invention electronically records the learner's answers to the test items, and calculates a new level of difficulty, a new delivery interval, and a new content area for subsequent test items using the learner's answers previously recorded. The system then retests the learner about the concept using subsequent test items based on the calculation of the new level of difficulty, the new delivery interval, and the new content area.

In one embodiment, the duration of the delivery interval and/or level of difficulty of the subsequent test items are increased for test items that have been answered correctly and are decreased for test items that had been answered incorrectly. Additional processes may also be used to calculate a new level of difficulty, a new delivery interval, and/or a new content area for subsequent test items.

In another embodiment, the method of the present invention may additionally include the step of providing the learner with the correct answers to the test items or educational materials regarding the concept addressed by the test item. The correct answers and educational materials foster additional learning about the concept. This step is particularly useful where the learner answered the test item incorrectly.

In one embodiment of the present invention, retesting is performed using subsequent test items, and the retesting continues until the learner's ability to retain the concept reaches a pre-defined level of proficiency. A pre-defined level of proficiency can include, for example, successfully answering 80% of all test items correct twice in a row. At that point, the concept can be retired, and a new concept may be tested. If desired, the “retired” concept can be reintroduced in the future to promote retention of the concept.

In one embodiment, a test item is delivered to the learner through electronic media or through electronic mail (e.g., email). The email may contain a hyperlink to a web page where the learner can review a question and/or may submit an answer to the test item. This provides for interactivity needed to allow for real-time recording of answers and customizing of future test items, such as additional questions or educational material, and the like. The learner's answer may be provided by selecting from a multiple-choice set of answers. The email may be received by any electronic device capable of receiving email such as computer, including a desktop or laptop computer, a mobile phone, a personal digital assistant such as a Blackberry™, Trio™, or Sidekick™, and the like. The calculating step may be performed at a central server.

In another embodiment, the learner's answer to the test item can be submitted in a range of formats including, short answers, multiple choice, matching, identification of an element in a picture or video or audio presentation, performance of a skill monitored by the electronic recording device (e.g., typing, drawing blood, setting up electrocardiogram (ECG) leads, etc.), and the like. The test item may require the learner to demonstrate a skill (e.g. typing accurately, typing for speed, performing tasks using a computer program, tapping out Morse code on a keyboard, identifying lead positions for an ECG set-up, etc.), and the learner's answer is the level of proficiency demonstrated, that is, how well he performs this skill, as measured by the electronic recording device.

In another embodiment, the calculating step is performed by a software method contained in the learners' electronic device itself, such as in a desktop or laptop computer, a mobile phone, a personal digital assistant, and the like. The test items and/or educational materials may also be contained within the learner's electronic device as well. Alternatively, the method of the present invention may be performed by a central server that delivers content, such as the test items, the educational materials, the correct answers, and the like, to a user over a network connection or other communication link.

The concepts and conceptual items may be independent (e.g., facts) or may be components of a target curriculum, sometimes referred to as “educational elements.” Target curricula include, as examples, medical studies such as kidney pathology, as well as Spanish vocabulary, math concepts, such as multiplication and division, as well as Scholastic Aptitude Test (SAT) practice questions.

In certain embodiments, the temporal spacing of the test items at initial presentation is adapted to the needs of a learner, such that a learner with a lower baseline knowledge level is presented with test items at a higher frequency than a learner who had a higher level of baseline knowledge in a given content area.

The system of the present invention provides components necessary to accomplish the methods of the invention. A system in accordance with the present invention includes a test item delivery module in tandem with a recording module, a feedback module, a calculation module, and a retesting module that work in concert to provide delivery of a test item, record a learner's interaction with the test item, calculate and provide the learner with feedback related to the test item, and customize the future delivery of a subsequent test item. Such components include, for example, test items related to the items of information, software for delivering the test items and a computer for calculating a new level of difficulty, a new delivery interval, and a new content area for subsequent test items.

### BRIEF DESCRIPTION OF THE DRAWINGS

The accompanying drawings illustrate an embodiment of the invention and depict the above-mentioned and other features of this invention and the manner of attaining them. In the drawings:

FIG. 1 shows a flowchart illustrating a process of an online adaptive spaced education system in accordance with the present invention.

FIG. 2 is a screen shot illustrating an example of a spaced education email in accordance with the present invention.

FIG. 3 is a screen shot illustrating an example of a spaced education test item web page in accordance with the present invention.

FIG. 4 is a screen shot illustrating an example of a spaced education answer web page in accordance with the present invention.

FIG. 5 shows a flowchart and time line illustrating an example of adaptive changes in the difficulty of test items relating to teaching state capitals in accordance with the present invention.

FIG. 6 illustrates a flow chart and time spacing pattern of test items and the manner in which the test items are altered using an adaptive spacing process in accordance with the present invention.

FIG. 7 is a flowchart illustrating an example of a manner in which adaptive difficulty and adaptive spacing are combined in the OASE program in accordance with the present invention.

FIG. 8 is a flow diagram illustrating learning cycles based on the adaptive spacing and difficulty process of FIG. 7.

FIG. 9 is a flowchart and time line illustrating another example of adaptive changes in the difficulty of test items relating to teaching multiplication to school children in accordance with the present invention.

FIG. 10 is a graphical plot illustrating the efficacy of the OASE program in accordance with the present invention in generating and maintaining the learning of individual physicians as part of a mandatory Maintenance of Certification program.

FIG. 11 is a screen shot illustrating a spaced education email of a test pages displaying one embodiment of the present invention utilized at Harvard Medical School.

FIG. 12 is a screen shot illustrating an example of a spaced education test item web page displaying one embodiment of the present invention utilized at Harvard Medical School.

FIG. 13 is a screen shot illustrating an example of a spaced education answer web page displaying one embodiment of the present invention utilized at Harvard Medical School.

FIG. 14 is a screen shot of the OASE System Set-up page of one embodiment of the present invention utilized at Harvard Medical School.

FIG. 15 is a schematic drawing of an adaptive spaced teaching system in accordance with the present invention

### DETAILED DESCRIPTION OF THE INVENTION

The following detailed description of the invention refers to the accompanying drawings and to certain preferred embodiments, but the detailed description of the invention does not limit the invention. The scope of the invention is defined by the appended claims and equivalents as it will be apparent to those of skill in the art that various features, variations, and modifications can be included or excluded based upon the requirements of a particular use.

A. Spaced Education

Spaced Education refers to learning and educational programs that combine the “spacing effect” of learning along with the “testing effect”. Educational encounters that are temporally spaced and repeated over time result in more efficient learning and improved learning retention. Similarly, the “testing effect,” or the act of retrieving information, as compared to simply reading or hearing the information, also results in enhanced memory and improved learning.

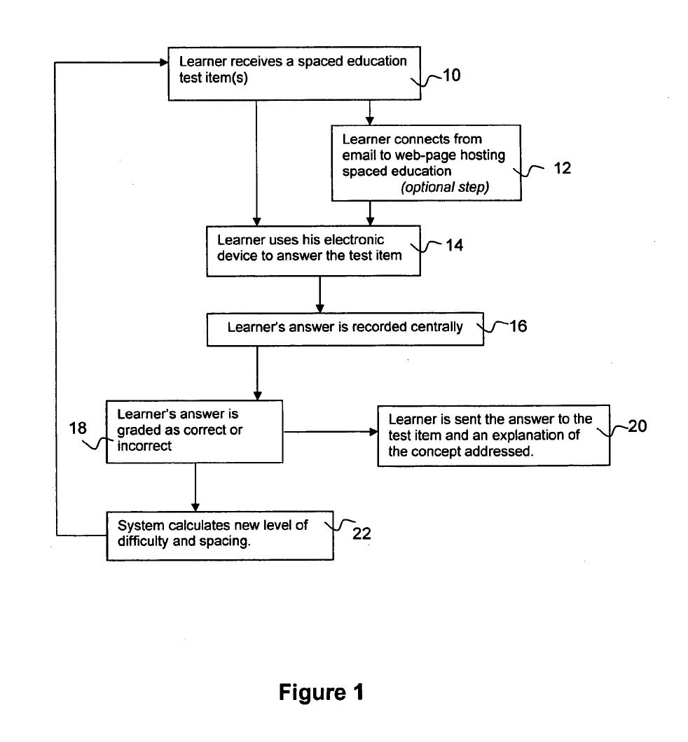

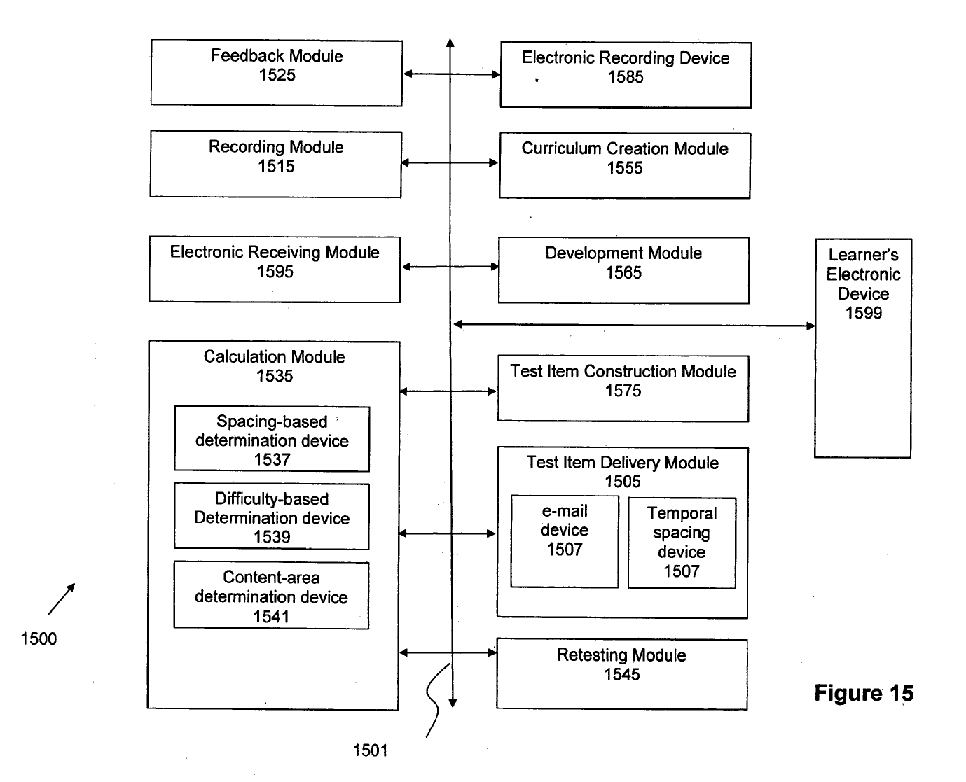

FIG. 1 illustrates a flowchart of a Spaced Education process of delivering test items and educational material to learners via electronic media, such as email and the like, over spaced intervals of time. Similarly, FIG. 15 illustrates components configured to perform the spaced education process of the present invention.

For use in teaching a target curriculum, a set of curricular objectives is created using curriculum creation module 1555, and from these curricular objectives, a set of test items and educational materials are developed that address the curricular objectives using development module 1565 and test item construction module 1575. These test items and educational materials are constructed to utilize the full range of web-based content delivery methods. Examples include medical case scenarios with multiple-choice questions, audio of heart murmurs to be identified, videos of surgical procedures to be analyzed, and the like.

Referring again to FIG. 1 and to FIG. 15, the system and the overall flow of one embodiment of the present invention is shown. In step 10, a learner receives a spaced item of information, such as an educational test item(s) via email or via other electronic or online distribution systems from test item delivery module 1505 using email device 1507. An electronic receiving module 1595 receives the test item. The electronic receiving module 1595 may be included in a learner's electronic device 1599, such as a computer, a laptop, a portable system such as a Blackberry™, cell phone, Palm Pilot™, and the like, may also be used with which to electronically deliver and to receive the test item over a computer network 1501, such as the Internet or other communication network.

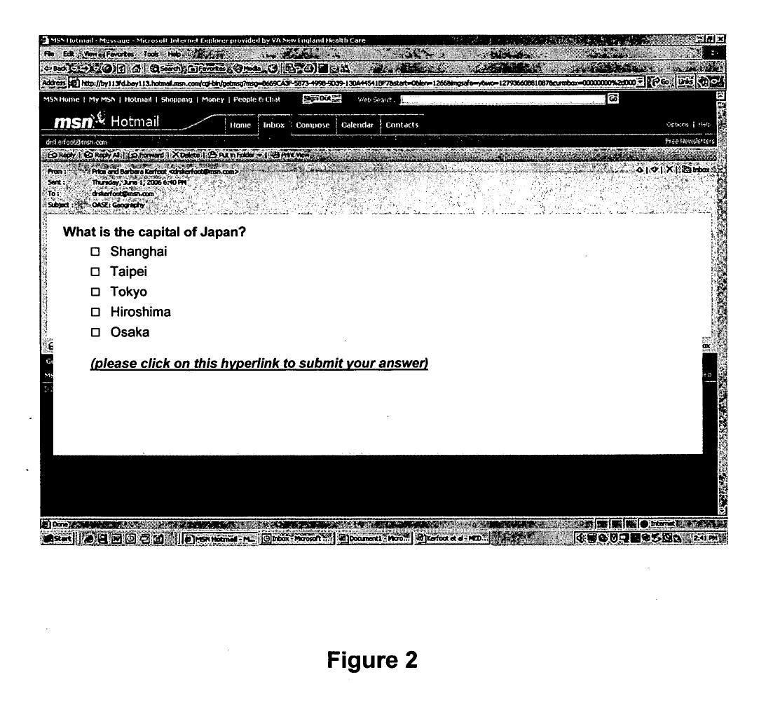

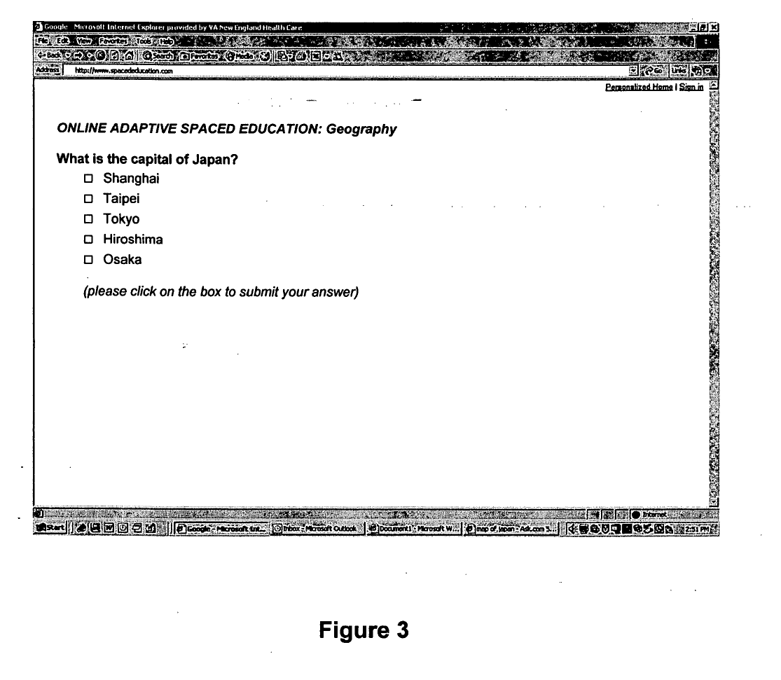

The learner receives these test items via electronic means such as by electronic mail as shown in FIG. 2, or, optionally, by an electronic link to a web page that presents the test items as illustrated in FIG. 3. The learner's answer to the test item is recorded in a manner so that it is linked to a learner's unique identifier, such as the learner's name, student ID number, email address, and the like. As shown in FIG. 3, one manner of linking the answers to the learner's unique identifier is by having the learner click on a hyperlink in the initial email, which opens a new web page containing the spaced education test item (shown in FIG. 3). This new web page recognizes the unique email address of the person who opened it, and the answer to the test item is then linked to this user by his unique email address. Additional methods of linking the learner's answers to the learner's unique identifier may also be employed, including establishing a learner's unique identify by password, computer cookie, and the like.

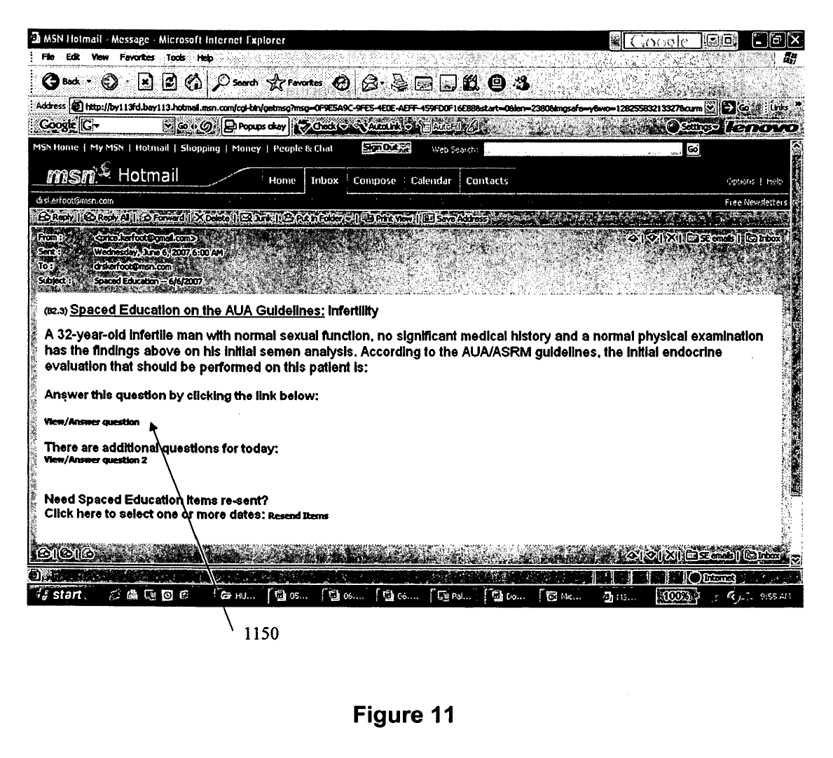

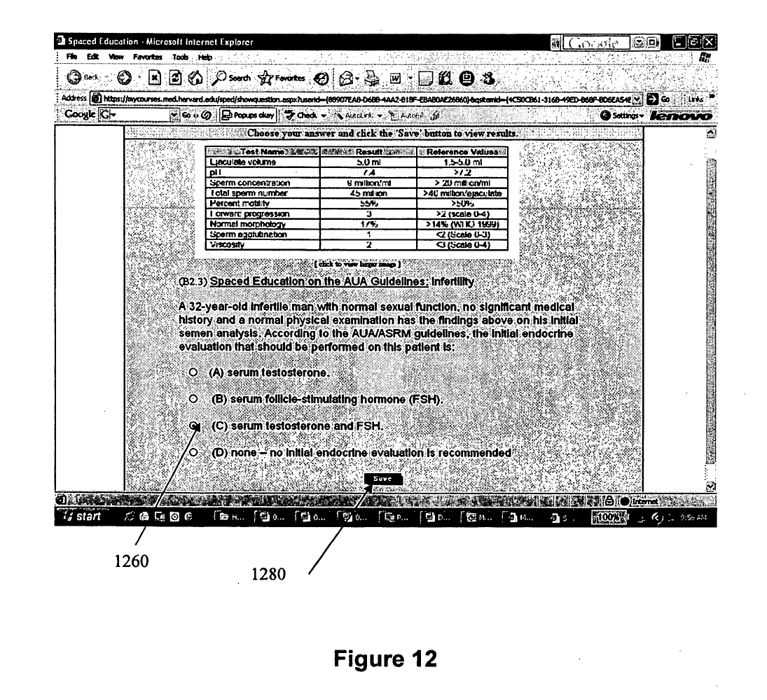

For example, an additional example of a spaced education email from on-going program of 480 urologists and urology trainees is shown in FIG. 11. In this example, the learner (urologist or urology trainee) receives the spaced education test items via email or other electronic online distribution system, and to view the clinical test results and the possible answers to the test item, the learner must click on the “View/Answer question” hyperlink 1150. A new window then opens as illustrated in FIG. 12.

The learner receives these test items with structured repetition over spaced intervals of time. For instance, a medical student receives a daily email, which contains a hyperlink to a web page that presents a new heart-murmur each day and asks the student to recognize it.

Returning to FIG. 1, in optional step 12, the learner connects from the email to a web page hosting the spaced education material as shown in FIG. 3. The learner connects from the email to the web page using, for example, the hyperlink that is provided in the email.

In step 14, the learner attempts to answer the test item using an electronic device 1599, such as the computer or mobile device, or the like, with which the learner accessed the email. In one embodiment illustrated in FIG. 2 and in FIG. 3, the learner provides the answer to the test item by selecting from a multiple-choice array of answers. Likewise, the questions may also be structured to require the learner to respond by electronically submitting an answer in a short answer format, a matching format, and the like. Additionally, the learner may be required to answer test items by identifying an element in a picture, identifying an element in a video, or identifying an element in an audio recording. Similarly, the learner may be required to perform a task, such as typing a passage of text, or placing ECG leads in a proper configuration, or similar performances as indicative of the answer to the questions provided by the system. In these situations, with performance of the learner serving as the answer to the test item, electronic recording device 1585 may track and record the learner's performance.

As shown in the example of FIG. 12, an example is shown of an answer page used in conjunction with the spaced education test item web page of FIG. 11. The learner (urologist or urology trainee) provides an answer to the test item that is recorded and linked to the learner's unique identifier, such as the learner's name, ID number, email address, and the like. By clicking on the hyperlink 1150 in the email, this new web page illustrated in FIG. 12 recognizes the unique email address of the person who opened it, and the answer 1260 to the test item is then linked to this user by his unique email address. On this web-page, the learner reads the clinical test results, selects an answer to the test item, and clicks the “Save” button 1280.

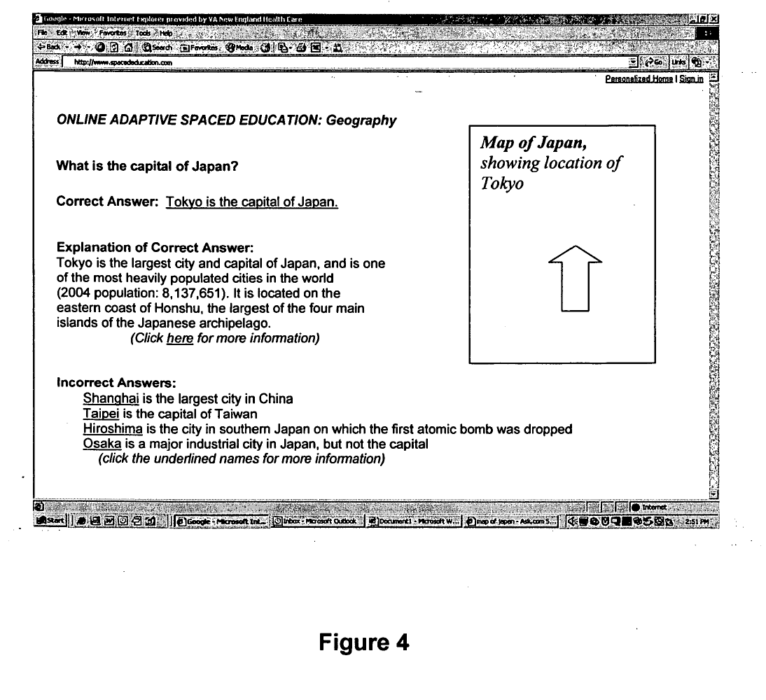

Returning to FIG. 1, in step 16, the selected answer is then delivered via email or by Internet-based communication to recording module 1515 in a central computer server that records the learner's answer. Alternatively the answer may be provided and transferred internally to a recording module 1515 resident in the learner's electronic device 1599, such as a computer or a mobile electronic device that also has access to test items and learners' responses. As shown in step 18, a feedback module 1525 evaluates the answer, and the answer is graded as correct or incorrect. In step 20, the learner is notified if the test item was answered correctly. Optionally, the learner is sent, for example, the explanation to the correct and incorrect answers as illustrated in detail in FIG. 4. Additionally, further supplementary educational materials, hyperlinks to other education materials, and additional feedback regarding the learner's performance on the spaced education program may also be sent to the learner along with the explanations, or in additional emails and electronic deliveries to optimize learning.

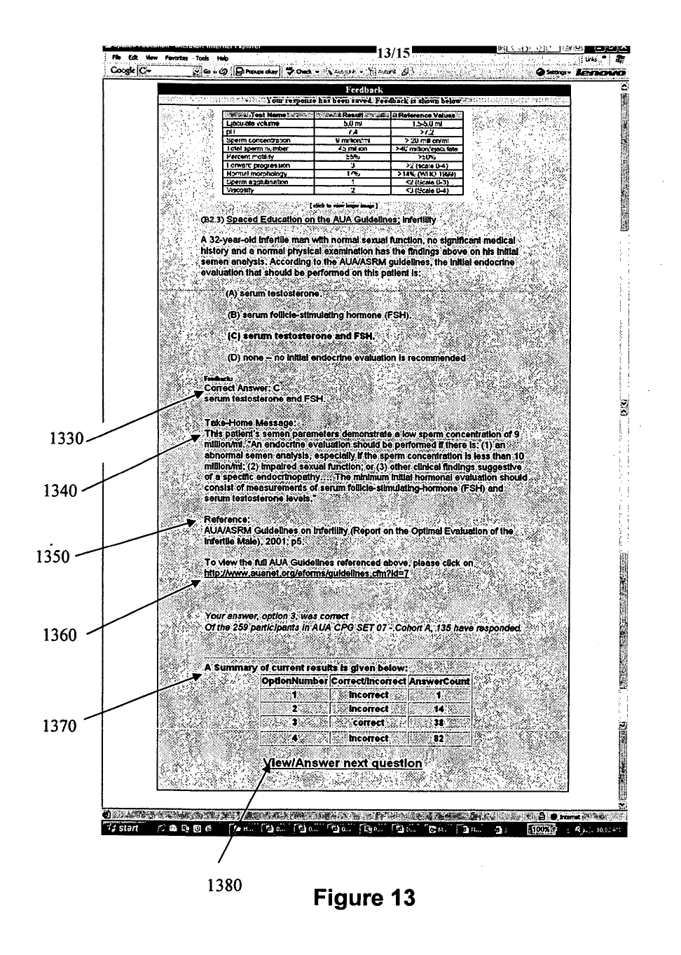

As shown in the example of FIG. 13, an answer web page is used in conjunction with the spaced education test item web page of FIG. 11. Once the learner submits his answer to the test item, this answer is recorded electronically centrally in a server, and the learner is then provided with a web-page which provides the correct answer 1330, a take-home message 1340 explaining the correct answer, references 1350 to relevant information, a hyperlink 1360 to this reference, and a table 1370 displaying how other participants in the program answered this test item. To move to the next test item in this email, the learner clicks the “View/Answer next question” hyperlink 1380 and a web page containing the next test item is displayed.

As further illustrated in FIG. 1, the calculation module 1535 of the system, in step 22, uses the answer provided to calculate a new level of difficulty, a new content area, a new repetition pattern, and a new schedule for delivery of subsequent test items (including the spacing of delivery for subsequent test items). The system and method of the present invention is customized based on the learner's demonstrated knowledge of the material as evidenced from answers to the test items. Calculation module 1535 may determine that one of these factors may be changed, or that any combination of the factors may be changed, or that all factors may be changed depending upon the electronically recorded answers provided by the learner. Calculation module 1535 determines a spacing-based factor of the new delivery interval using spacing-based determination device 1537. The spacing-based factor may indicate that the calculated new delivery interval for delivery of subsequent test items is increased for test items that have been answered correctly. Similarly, spacing-based factor may indicate that the calculated new delivery interval for delivery of subsequent test items is decreased for test items that have been answered incorrectly. In the same way, calculation module 1535 may determine a spacing-based factor of the new delivery interval where the next two test items are delivered more quickly, that is with a decreased delivery interval, and after the next two test items, the delivery interval is to be increased. Likewise, the spacing-based factor may also indicate that the repetition pattern of delivered test items be altered. For example, the number and time between delivered test items regarding a particular content area may be increased or decreased depending upon the answers provided by the learner. Temporal spacing device 1507 of the test item delivery module 1505 provides the proper time interval with which to deliver subsequent test items.

System 1500 provides for customization and adapts the difficulty level, the delivery interval, and the content area of subsequent test items based on the learner's demonstrated knowledge level of the material. As indicated above, any or all of the factors may change based upon the calculation. For example, calculation module 1535 determines a difficulty-based factor of the new level of difficulty for subsequent test items using difficulty-based determination device 1539. The difficulty-based factor may indicate that the calculated new difficulty level for delivery of subsequent test items is increased for test items that have been answered correctly. Similarly, the difficulty-based factor may indicate that the calculated new difficulty level for subsequent test items is decreased for test items that have been answered incorrectly. In the same way, calculation module 1535 may determine a difficulty-based factor of the new difficulty level may be less for the next three test items, that is the difficulty level is decreased, and after those next three test items, the difficulty level is to be increased.

Similarly, calculation module 1535 determines a content area-based proficiency factor of the new content area using content-area determination device 1541. The content area-based proficiency factor may indicate that the calculated new content area for delivery of subsequent test items remains unchanged because a learner has not yet achieved a pre-established proficiency factor in the particular content area. Likewise, content area-based proficiency factor may indicate that the calculated new content area for delivery of subsequent test items should be changed because the learner has achieved a pre-established content area proficiency. For example, a medical student who answers fifty-four questions correctly out of fifty-four questions regarding the circulatory system may have a calculated content area-based proficiency factor that meets the pre-established proficiency factor for that particular content area (circulatory system). Subsequent delivered test items would then be with regard to a different content area, such as the endocrine system, for example. In contrast, a medical student who answers only three of fifty-four questions correctly regarding the circulatory system will likely have a calculated content area-based proficiency factor that does not meet the pre-established proficiency factor for that particular content area. Subsequent delivered test items would then be directed to the same content area (circulatory system) until the learner achieved a calculated content area-based proficiency factor that meets the pre-established proficiency factor for that circulatory system content area. As above, system 1500 provides for customization and adapts the difficulty level, the delivery interval, and the content area of subsequent test items based on the learner's demonstrated knowledge level of the material. Similarly, the content area-based proficiency factor may indicate that the calculated new content area for subsequent test items remains the same for the next six test items and then changes to a new content area.

In using the spacing-based factor, the difficulty-based factor, and the content area-based proficiency factor to adapt the subsequent test items, the delivery and repetition of the subsequent test items, the system and method of the present invention employs a customized adaptive process to take full advantage of the spacing effect and the teaching effect to provide improved learning efficiency and retention.

Once the calculation module 1535 determines the new level of difficulty and/or the new delivery interval and/or the new content area for the subsequent test item, the process returns to step 10, where the learner receives a new test item from retesting module 1545, where the new test item is based upon the newly calculated delivery interval, difficulty level, and content area.

B. Monitoring Learner Interactions with Online Educational Material

Extending the example above, a medical student who hyperlinked to a web-page that presented a test item including an audio heart murmur is asked, for example, to identify the heart murmur and to select an answer corresponding to which heart murmur the learner believes is correct. The learner's answer/response is then recorded in recording module 1515 on his computer or on a central server.

The future delivery of test items for each learner is customized with regard to the test item's content area, difficulty, and time interval of delivery based on information garnered from the learner's answers and interactions with the system 1500. The feedback module 1525 provides correct answers to the test items to the learner to foster learning about the conceptual item of information. The calculation module 1535 calculates whether the learner answered the question correctly and calculates a new level of difficulty, a new delivery interval, and a new content area for subsequent test items based upon the learner's electronically recorded answers.

By monitoring the learner's interaction with the test items, the delivery of future material is customized. For example, if the learner correctly identified the heart murmur, he is presented with a more difficult heart-murmur 4 days later. If he did not identify the heart murmur correctly, he is presented with a similar or an easier-to-recognize heart murmur 2 days later. The system is adaptive in that the material sent to the learner is individualized with regard to content, difficulty, and time interval of delivery to match their current knowledge level and thus to optimize their learning and retention of the material.

The system and method of the present invention includes a number of features that provide markedly superior results when compared to other conventional forms of web-based teaching. Online spaced education is extremely well accepted by learners, in stark contrast to conventional online modules currently in use today. A learner's progress toward acquisition of knowledge can be monitored, and using the adaptive mechanisms of the present invention, the educational materials can be customized and tailored to meet the needs of the individual learner. Maintenance of competency can be documented by whether or not a learner continues to demonstrate mastery of the test items over time. If knowledge levels are seen to drop, the content, difficulty, and/or spacing pattern of the test items can be altered to bring the learner back to a state of mastery in that subject area.

The adaptive online teach teaching system and method of the present invention may be used in a variety of environments, including the following examples:

(1) Teaching vocabulary to prepare grade-school students (learners) for the SAT. Students receive a vocabulary word every day via email. Upon clicking on a hyperlink in the body of the email, the learner is taken to a web-page to submit their definition of the vocabulary word (i.e., an answer), receive feedback on the correct answer, see how well their knowledge of vocabulary is growing, and see how well they are doing relative to their peers. If the learner gets the vocabulary term correct, the learner receives a more difficult test item the next day. If the learner gets the vocabulary term incorrect, the learner receives a test item of similar or reduced difficulty the next day, and that test item is repeated a week later.

(2) Retention of a foreign language as an adult. A similar model and process as described above with regard to vocabulary words is used to help an adult retain a foreign language. Given the audio functionality of the web, pronunciation may also be taught.

(3) Continuing Medical Education (CME) of physicians. Doctors are required to complete 50 hours of CME each year. If a physician received 10 minutes of CME credit for completing 2 spaced education test items each working day using the adaptive online teaching system of the present invention, by the end of the year she would complete 33 hours of CME toward her 50 hour requirement.

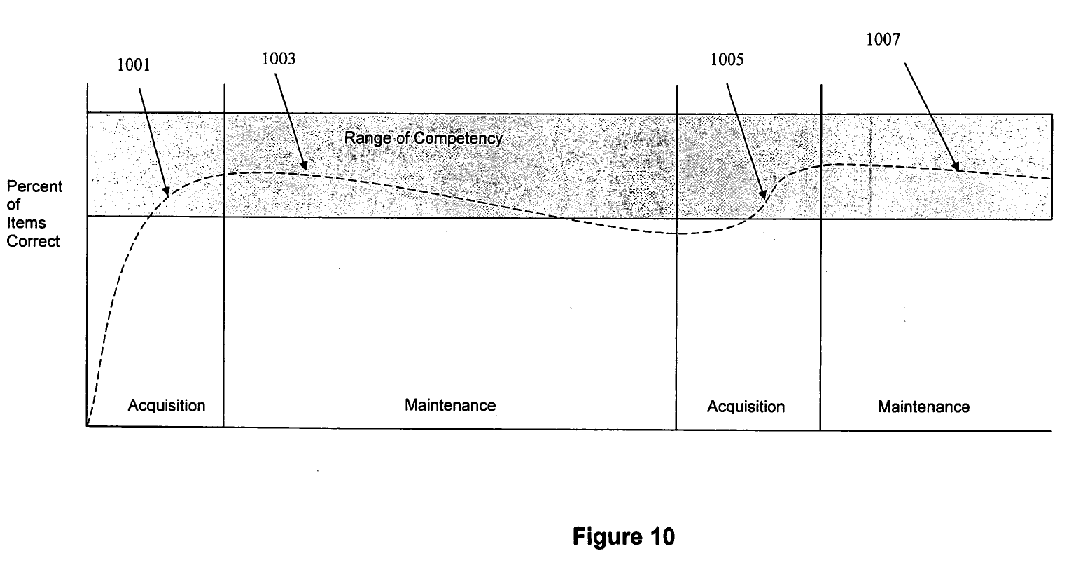

(4) Maintaining the certification of physicians in a longitudinal manner. A spaced education program, which balances acquisition and maintenance of clinical knowledge in this manner, would have particular valence given the new mandated models of physician “maintenance of certification.” For example, consider if the American Board of Internal Medicine required all internal medicine physicians to document proficiency at interpreting arterial blood gas (ABG) test results in order to maintain their Board certification. To acquire these skills, a physician completes an on-line adaptive spaced education (OASE) program, which consists of 40 spaced education test items on ABG interpretation. Test items related to ABG interpretation are delivered twice a week. Upon submission of answers to the test items, the physicians receive the correct answer and an explanation of the concept at hand. Once proficiency is obtained and certified (defined as answering all 40 test items correctly twice in a row), a follow-up program of maintenance OASE maintains these skills over time. As illustrated by the competency chart in FIG. 10, the system and method of the present invention serves to acquire the interpretive skills and to maintain the demonstrated skills over time. The “acquisition” portion of the OASE program is shown by dashed line 1001. In the maintenance program portion 1003, the physician may receive new ABC spaced education test items once a month (rather than twice a week when in the “acquisition” stage of the competency program) in order to ensure that these interpretive skills remain easily accessible in the physician's working memory. If he or she begins to answer a significant number of these monthly test items incorrectly, the system and method of the present invention then reverts back to an OASE program of greater frequency 1005 (that is, test items are delivered more frequently using shorter spacing-intervals between delivery of the test items) to redress these memory losses and the performance degradation. Once proficiency is achieved again, the OASE program could then shift back to the maintenance mode as depicted as 1007 in FIG. 10. As physicians grapple with the new maintenance of certification requirements being instituted across the United States, the OASE of the present invention serves to develop, remediate, maintain and certify physicians' abilities to deliver high quality care.

(5) Improving sales of commercial products. For example, an herbal remedy store offers a free online adaptive spaced education program to its customers. While customers learn about the ins-and-outs of herbal remedies through daily test items delivered via email, the explanations to the test items also contain advertising for relevant herbal products, which customers can order from this supplier. In this case, the methods for adapting the content, difficulty, and spacing of the educational material are designed to optimize sales of herbs to the consumer.

(6) Aligning providers' clinical behaviors with evidence-based clinical practice guidelines (CPGs). It is well documented that physicians and other care providers poorly adhere to evidence-based CPGs. In the case of Prostate-specific antigen (PSA) screening for prostate cancer, the OASE system and method of the present invention may reduce the rate of inappropriate screening, reduces patient anxiety, reduces patients' loss of work, reduces the rate of unnecessary prostate biopsies, and results in a substantial cost saving for the health system as a whole. The true value of the OASE system and method of the present invention goes well beyond PSA screening and prostate cancer, for this training process may be expanded and utilized to increase providers' adherence to clinical practice guidelines (CPGs) for the treatment of many other cancers and diseases. For example, the National Comprehensive Cancer Network currently lists CPGs for 34 different classes of cancers. Given the ubiquitous use of email and of the Internet by care providers, this online spaced educational program is easily expanded to a broad audience of healthcare professionals across the country. By bringing providers' clinical behaviors into greater alignment with evidence-based standards, OASE may significantly improve the quality of healthcare delivery in the U.S.

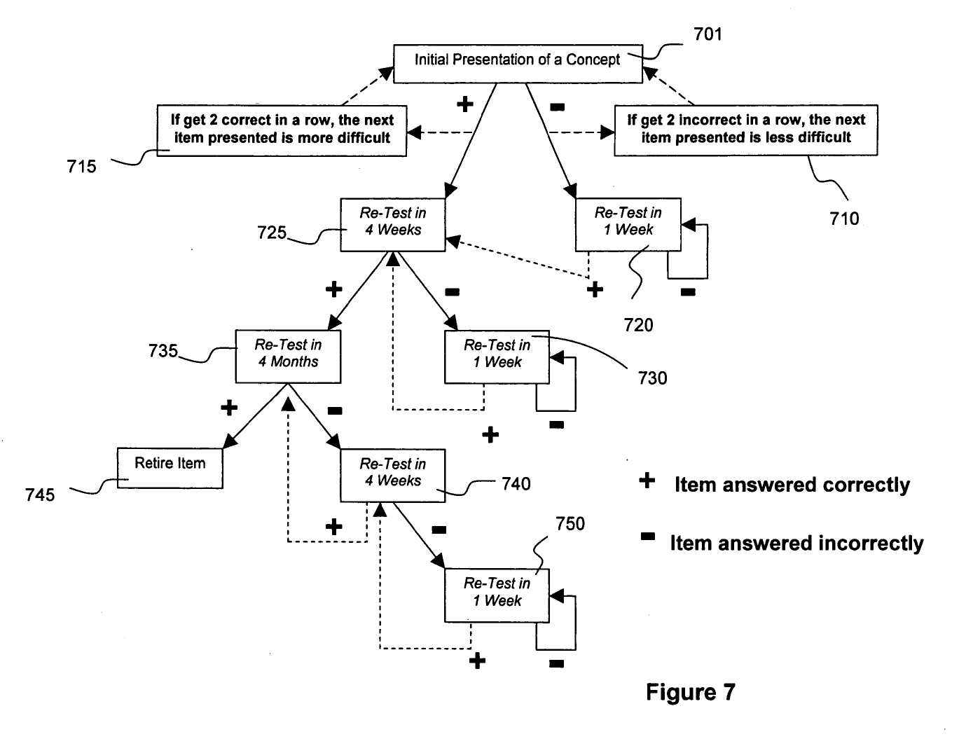

FIG. 7 shows a manner in which adaptive difficulty and adaptive spacing are combined in the OASE program using the system and method of the present invention. To highlight the features, adaptive difficulty is illustrated in bold text while adaptive spacing is shown in italics. The “plus” symbol (+) represents answering the test item or concept correctly, while the minus symbol (−) represents answering the test item incorrectly. As illustrated in FIG. 7, the method of the present invention provides adaptive difficulty and adaptive spacing based on the correct and incorrect answers the learner provides to the test items. In this embodiment, the adaptive difficulty is utilized to customize the difficulty of test items at initial presentation, while the adaptive spacing is utilized to customize the subsequent retesting intervals.

In step 701, a test item on a concept is initially presented to the learner. The learner provides an answer. If the answer is correct, the learner follows the +path to step 725 and is retested on this concept 4 weeks later. The learner receives another test item the following day. If the learner answers it correctly, the learner follows the +path to step 725 and is retested on this second concept 4 weeks later. Since now two test items have been answered correctly in a row, the learner also follows the path to step 715 so that subsequent test items presented for the first time to the learner will increase in difficulty. That is, the system employs adaptive difficulty to increase the difficulty level of the test item.

If after the initial presentation of a conceptual item, the learner answers incorrectly, the learner follows the—path to step 720 and is retested on this concept 1 week later. The learner receives another test item the following day. If the learner answers it incorrectly, the learner follows the—path to step 720 and is retested on this second concept 1 week later. Since now two test items have been answered incorrectly in a row, the learner also follows the path to step 710 so that subsequent test items presented for the first time to the learner will decrease in difficulty. That is, the system employs adaptive difficulty to decrease the difficulty level of the test item.

Similarly, if the learner answered the question correctly in step 715, the learner advances to step 725 and is retested on the concept if four weeks. If the learner in step 720 correctly answers the test item during the retest in step 720, the learner also advances to step 725 to be retested on that same conceptual idea in four weeks. If a learner in step 725 answers incorrectly, the learner is retested in one week in step 730. If, in step 730 the learner answers incorrectly, they are retested in one week. If the learner answers incorrectly twice in a row, the next item presented is less difficult. Alternatively, if the learner in step 730 answers correctly, the learner repeats step 725 and is retested in four weeks.

Once the learner answers the test items correctly in step 725, the learner progresses to step 735 where they are retested in four months. If the learner correctly answers the test items in step 735, the item is retired in step 745. However, if the learner answers the test item incorrectly in step 735, the learner is retested in four weeks in step 740. If the learner answers correctly in step 740, the learner repeats step 735 and is retested in four months. If the learner answers the test item for the conceptual idea incorrectly in step 740, the adaptive spacing is reduced again (that is the retesting occurs more frequently) and the learner is retested in one week in step 750. If the learner continues to answer test items incorrectly in step 750, the retests continue each week until the learner begins to demonstrate proficiency, and the learner returns to step 740, where the adaptive spacing is increased. Similarly, as the learner continues to answer test items correctly, the adaptive spacing continues to increase and the learner returns to step 735 and ultimately demonstrates mastery of the conceptual idea, and the test item is retired in step 745.

By adapting the difficulty and the spacing of the test items, the learner progresses through test items until mastering the conceptual idea represented by the test items. The iterative process illustrated in FIG. 7 may be modified using additional adaptive spacing and difficulty, and milestones (for example, the number of test items answered correctly before progressing to the next step or the number of test items answered incorrectly before repeating a step) may be modified based upon the learning environment, the type and composition of the test items, the time allotted to complete the entire process, and additional factors.

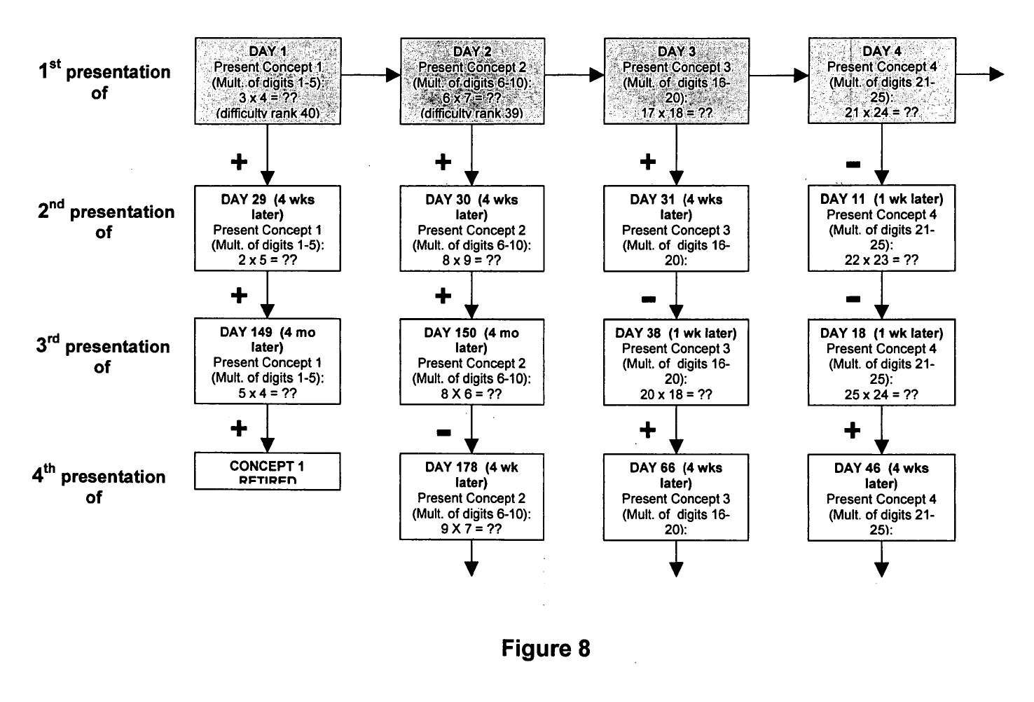

FIG. 8 is a flow diagram illustrating learning cycles based on the adaptive spacing and difficulty process of FIG. 7. The symbol (+) represents answering the test item/concept correctly, while (−) represents answering the test item/concept incorrectly.

As outlined above with regard to FIG. 7, the adaptive spacing and difficulty process of the on-line adaptive spaced education (OASE) system presents new concepts of increasing difficulty to a learner each day via a spaced education email. If the learner answers that test item incorrectly (as depicted by the symbol −), the concept is repeated 1 week later. If the learner answers that test item correctly (the symbol +) the first time, the concept is repeated 4 weeks later. If the learner answers that test item correctly for a second time in a row, the concept is repeated 4 months later. Once each concept is answered correctly three times in a row, that particular concept is retired and no additional test items pertaining to that concept are delivered. The on-line adaptive spaced education (CASE) process ends when the learner retires all the educational items. For example, the difficulty of the item presented on Day 3 increased (from difficulty rank 39 to 34) since the learner answered the test items correctly on Days 1 and 2. The specific test items presented and repeated may be variations within a given concept. For example, the test items 3×4=?, 2×5=?, 5×4=? are all variations of the concept of “multiplication of digits 1-5”.

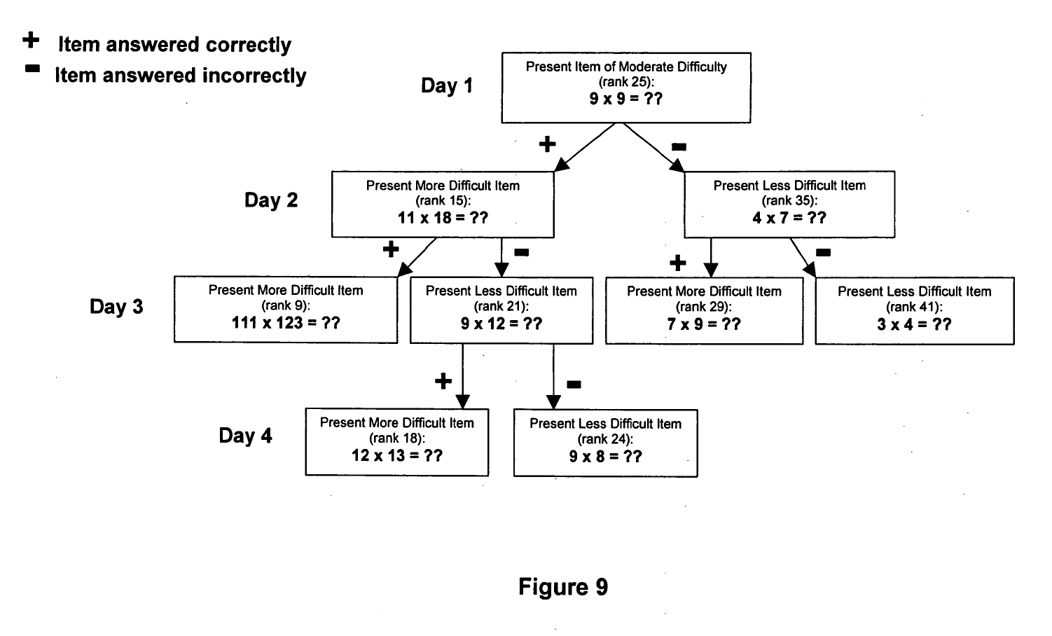

FIG. 9 is a flowchart and time line illustrating the on-line adaptive spaced education (OASE) process to teach multiplication to schoolchildren. Adaptive changes in the difficulty of test items is illustrated where the test items (questions) are ranked in order of difficulty based on pilot testing of a similar population of learners. In the example shown in FIG. 9, the rank of difficulty goes from 1 (most difficult) to 50 (least difficult). The learner's (student) answer to the item, whether the response is correct or incorrect determines the difficulty of the subsequent new test item presented to that learner (student).

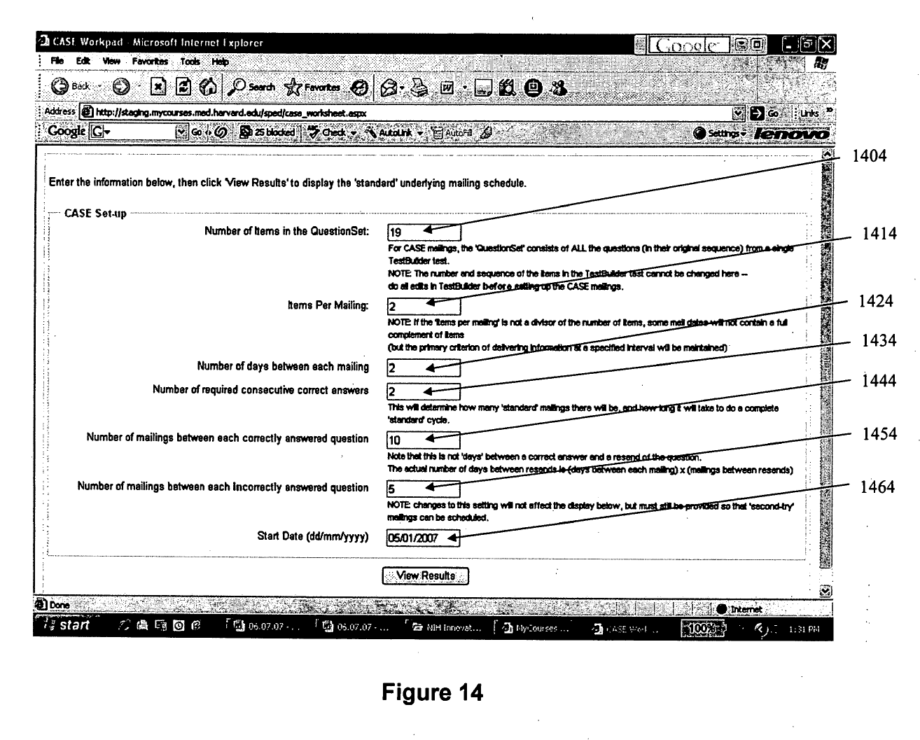

FIG. 14 is a screen shot of the OASE System Set-up page of one embodiment of the present invention utilized at Harvard Medical School. FIG. 14 includes parameters used to establish a spacing-based method in which the spacing interval between repetitions of a test item is determined by whether the learner's answer to that test item is correct or not. The system set up system provides a flexible format with which the on-line adaptive spaced education (OASE) process may be used to calculate the frequency of deliveries of test items as well as specifics regarding the number, type, frequency, and duration of the on-line program. The number of items in the question set 1404 includes the test items that may be presented to the learner and to which the learner provides an answer. The number of items 1404 is set and forms the basis with which the test items are evaluated with regard to difficulty and content area.

The number of items per mailing 1414 is established to provide a consistent test item set for which the learner will provide answers. The number of days between each mailing 1424 is initially established to provide the baseline timeframe for delivery of the test items. The number of required consecutive correct answers 1434 also establishes the criteria for proficiency (that is, the criteria for retirement of a test item) as the learner masters the content area. Additionally, the number of mailings between each correctly answered question 1444 is the actual number of days between resends and is equal to the number of days between each mailing multiplied by the mailings between resends. The number of mailings between each incorrectly answered question is used to establish the delivery schedule of subsequent second try test item mailings. The start date 1464 is used to establish the time frame during which the on-line adaptive spaced education process will be used and is also employed to establish the test item delivery schedule.

It is understood that the foregoing detailed description and the following examples are illustrative only and are not to be taken as limitations upon the scope of the invention. Various changes and modifications to the disclosed embodiments, which will be apparent to those skilled in the art, may be made without departing from the spirit and scope of the present invention. Further, all patents, patent applications, and publications cited herein are incorporated herein by reference.

With this configuration, the system 1500 of FIG. 15 is extremely flexible and responsive to individual on-line adaptive spaced education requirements for a particular environment. In addition to the above examples, an example of a program to teach the capitals of the 50 U.S. States may be found in APPENDIX A.

The method of the present invention is reliably fast and accurate, and provides an adaptive spaced education system to facilitate long-term learning and retention by providing structured repetition over spaced intervals of time. By capitalizing on the merits of the testing effect and spacing effect, the system leverages these phenomena to facilitate greater understanding of the presented subject matter.

The devices and subsystems of the embodiments of FIGS. 1-15 are for illustrative purposes, as many variations of the specific hardware used to implement the embodiments are possible, as will be appreciated by those skilled in the relevant arts. For example, the functionality of one or more of the devices and subsystems of the embodiments of FIGS. 1-15 can be implemented via one or more programmed computer systems or devices.

To implement such variations as well as other variations, a single computer system can be programmed to perform the special purpose functions of one or more of the devices and subsystems of the embodiments of FIGS. 1-15. On the other hand, two or more programmed computer systems or devices can be substituted for any one of the devices and subsystems of the embodiments of FIGS. 1-15. Accordingly, principles and advantages of distributed processing, such as redundancy, replication, and the like, also can be implemented, as desired, to increase the robustness and performance of the devices and subsystems of the embodiments of FIGS. 1-15.

The devices and subsystems of the embodiments of FIGS. 1-15 can store information relating to various processes described herein. This information can be stored in one or more memories, such as a hard disk, optical disk, magneto-optical disk, RAM, and the like, of the devices and subsystems of the embodiments of FIGS. 1-15. One or more databases of the devices and subsystems of the embodiments of FIGS. 1-15 can store the information used to implement the embodiments of the present invention. The databases can be organized using data structures (e.g., records, tables, arrays, fields, graphs, trees, lists, and the like) included in one or more memories or storage devices listed herein. The processes described with respect to the embodiments of FIGS. 1-15 can include appropriate data structures for storing data collected and/or generated by the processes of the devices and subsystems of the embodiments of FIGS. 1-15 in one or more databases thereof.

All or a portion of the devices and subsystems of the embodiments of FIGS. 1-15 can be conveniently implemented using one or more general purpose computer systems, microprocessors, digital signal processors, micro-controllers, and the like, programmed according to the teachings of the embodiments of the present invention, as will be appreciated by those skilled in the computer and software arts. Appropriate software can be readily prepared by programmers of ordinary skill based on the teachings of the embodiments, as will be appreciated by those skilled in the software art. Further, the devices and subsystems of the embodiments of FIGS. 1-15 can be implemented on the World Wide Web. In addition, the devices and subsystems of the embodiments of FIGS. 1-15 can be implemented by the preparation of application-specific integrated circuits or by interconnecting an appropriate network of conventional component circuits, as will be appreciated by those skilled in the electrical arts. Thus, the embodiments are not limited to any specific combination of hardware circuitry and/or software.

As stated above, the devices and subsystems of the embodiments of FIGS. 1-15 can include computer readable media or memories for holding instructions programmed according to the teachings of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

In order to further minimize the overall processing time required to deliver, record, provide feedback, calculate adaptive changes, and retest, the system of the present invention may index information content and store these indexed data within the devices of system 1500. If a tester or learner anticipates that they will review the same test items or educational materials in the future, the system can index the test items and educational materials and store the results. When an indexed and stored data set is then retrieved or accessed, the profile, network, content characteristics, as well as display characteristics may be retrieved for those stored results, and the relevant materials may simply be updated with additional data that may now be accessible. The information content previously available may be recalled from the system 1500 to reduce the overall execution time.

The foregoing description of the aspects and embodiments of the present invention provides illustration and description, but is not intended to be exhaustive or to limit the invention to the precise form disclosed. Those of skill in the art will recognize certain modifications, permutations, additions, and combinations of those embodiments are possible in light of the above teachings or may be acquired from practice of the invention. Therefore, the present invention also covers various modifications and equivalent arrangements that fall within the purview of appended claims.

### Appendix A

### EXAMPLE

### Program to Teach the Capitals of the 50 U.S. States

Test items are constructed in the multiple choice question format, as shown, for example, in FIG. 2.

The test items are pilot-tested by a sample of learners, which is representative of the larger target population of learners.

The test items are ranked according to difficulty (most difficult=rank 1; least difficult=rank 50) based on the pilot-test results.

The learners receive a daily spaced education email containing a test item.

Each spaced education email contains a test item and a hyperlink to a website where the learner's answer to the test item is submitted.

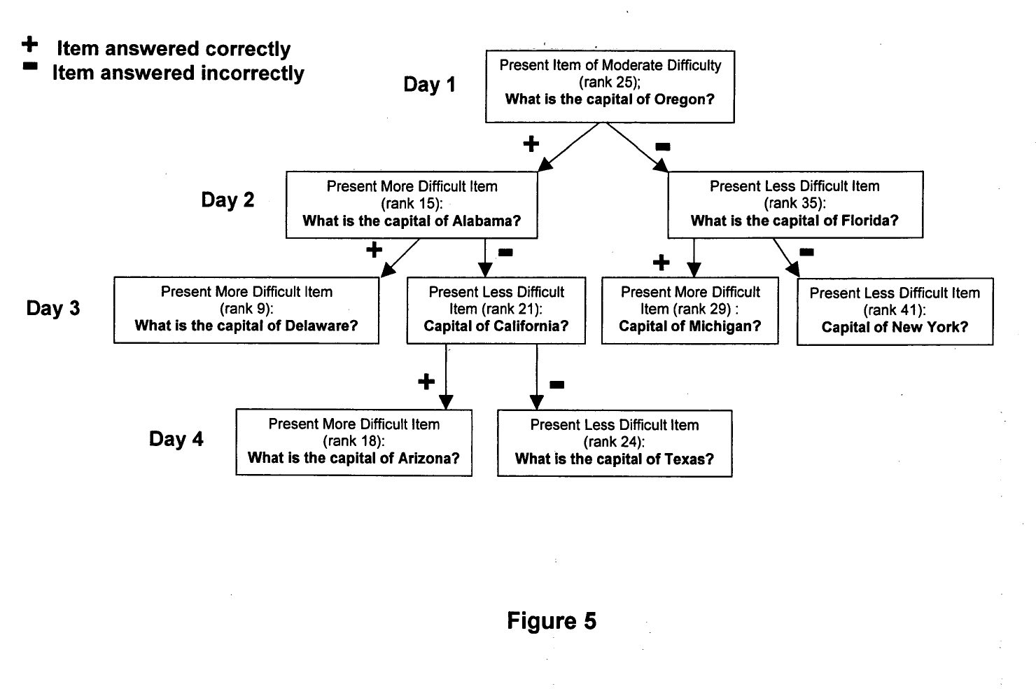

As the learners answer the test items, the difficulty of the newly-presented test item material is adapted to match the learner's current knowledge levels (see FIG. 5, for example). Once the current knowledge level (item difficulty level) for each learner is determined, that learner is then presented with new test item material at that difficulty level or greater. For example, a learner might get an item of rank 25 incorrect, an item of rank 35 incorrect and an item of rank 40 correct. The learner would then begin to receive test items of rank 39, 38, 37, etc. Another learner in the same program might receive test items of rank 20, 19, 18, etc.

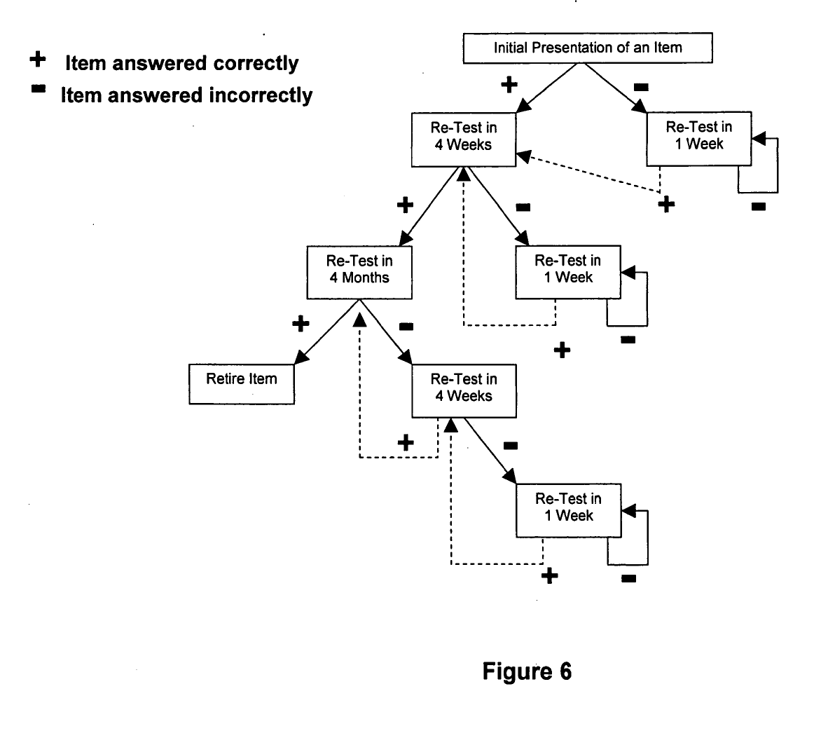

Once the learner answers a test item correctly or incorrectly, the spacing of repetition would then be determined according to an adaptive spacing method, such as that illustrated in FIG. 6.

Proficiency can be defined in multiple ways. In the example above, proficiency may be defined as correctly answering all of the items up to a difficulty rank of 1 twice in a row. Thus, the duration until proficiency is achieved will be shorter for those learners with a higher baseline knowledge level. It is also possible to increase the frequency of item presentation to the learners with a lower baseline knowledge level in order to allow them to achieve proficiency in a comparable time period.

The OASE system and method of the present invention starts to present test items in a new content area to the learner once the learner achieves a pre-defined proficiency threshold (level). Examples of this pre-defined threshold might include (1) the achievement of proficiency in the current content as defined above, or (2) the exhaustion of items, which can be newly presented. As an example of this latter threshold, the OASE system and method of the present invention may present items on the capitals of European countries once the US state capital items (up to difficulty rank 1) have already been presented.

### Appendix B

### Interactive Spaced Education to Teach the Physical Examination:

### A Randomized Controlled Trial

The inventors of the present invention recently completed a randomized controlled trial, which demonstrated that Spaced Education generates substantial learning and is extremely well-accepted among medical students. One-hundred-twenty students at Harvard Medical School were randomized to start an 18-week program in two groups, one starting in November 2006, and another starting 12 weeks later. Spaced education test items (questions and explanations) were developed on core topics and were content validated by multiple experts. Students were sent 6 spaced education emails each week for 6 weeks (cycle 1), which were then repeated in two subsequent 6-week cycles (cycles 2 & 3). Students submitted answers to the questions online and received immediate feedback. An online end-of-program survey was administered. Under an intent-to-treat analysis, the Spaced Education program caused students' baseline scores to increase from a mean 57.9% (SD 10.7) in cycle 1 to 74.4% (SD 13.9) in cycle 3 (p<0.001), corresponding to an effect size of 1.54. One hundred percent of survey respondents (102/102) recommended the Spaced Education program for fellow students the following year.

What is claimed is:

1. A method for improving a learner's ability to learn and retain a conceptual item of information, the method comprising:
testing a learner's understanding of the conceptual item of information by electronically delivering to the learner test items related to the conceptual item of information, wherein the delivery is over a spaced interval of time, and wherein the learner provides answers to the test items;
electronically recording the learner's answers to the test items;
providing correct answers to the test items to the learner to foster learning about the conceptual item of information;
calculating a new level of difficulty, a new delivery interval, and a new content area for a subsequent test item based upon the electronically recorded answers; and
retesting the learner based on the calculation of the new level of difficulty, the new delivery interval, and the new content area for a subsequent test item.

2. The method of claim 1 further comprising:
creating a set of curricular objectives;
developing a set of educational elements that teach the set of curricular objectives, wherein the educational elements include conceptual items of information; and
constructing test items for an electronic delivery method, whereby the test items demonstrate proficiency of the conceptual items of information.

3. The method of claim 1, wherein the calculating step includes determining a spacing-based factor of the new delivery interval, whereby the new delivery interval for delivery of a subsequent test item is increased for test items that have been answered correctly and the new delivery interval for delivery of a subsequent test item is decreased for test items that have been answered incorrectly.

4. The method of claim 1, wherein the calculating step includes determining a difficulty-based factor of the new level of difficulty, whereby the new level of difficulty of a subsequent test item is increased for test items that have been answered correctly and the new level of difficulty of a subsequent test item is decreased for test items that have been answered incorrectly.

5. The method of claim 1, wherein the calculating step includes determining a content area-based proficiency factor whereby the subsequent test item includes a new content area when the learner meets a pre-established content area-based proficiency factor.

6. The method of claim 1 further comprising providing educational material regarding the conceptual item of information to the learner to further foster learning about the conceptual item.

7. The method of claim 1, wherein the retesting step includes electronically delivering an additional test item to the learner, and wherein retesting continues until the learner's understanding of the conceptual item of information reaches a pre-established level of proficiency.

8. The method of claim 7, wherein the learner's understanding of the conceptual item of information includes a learner's ability to retain knowledge of the conceptual item of information.

9. The method of claim 1, wherein the test item is electronically delivered to the learner by electronic mail.

10. The method of claim 9, wherein the electronic mail comprises a hyperlink to a web page where the learner provides an answer to the test item.

11. The method of claim 1, wherein the calculating step is performed at a central server.

12. The method of claim 1, wherein the learner's electronically recorded answer is submitted in at least one format including short answer, multiple choice, matching, identification of an element in a picture, identification of an element in a video, or identification of an element in an audio recording.

13. The method of claim 1, wherein the test item requires the learner to demonstrate a skill and the learner's electronically recorded answer is measured by an electronic recording device to determine a level of proficiency at which the learner performs the skill.

14. The method of claim 1, wherein the testing step includes delivering the conceptual item of information to a computer, portable media device, personal digital assistant, or mobile email receiver.

15. The method of claim 1, further comprising delivering subsequent test items to the learner which pertain to a new content area when the learner meets a pre-established level of proficiency in a given content area.

16. The method of claim 1, wherein the electronically delivering the test item to the learner is adapted to the learning needs of the learner using temporal spacing, whereby a learner with a lower baseline knowledge level in a content area receives a subsequent test item more frequently than a learner having a higher baseline knowledge level in the same content area.

17. The method of claim 1, wherein the calculating step is performed by a learners' electronic device.

18. The method of claim 1, wherein the test items related to the conceptual item of information is delivered by a learner's electronic device for presentation to the learner.

19. The method of claim 6, wherein the educational material is provided by a learner's electronic device for presentation to the learner.

20. The method of claim 11, wherein the test item is delivered on-line over a network and the correct answers are provided on-line to the learner over the network.

21. A system for improving a learner's ability to learn and retain a conceptual item of information, the system comprising:
a test item delivery module that electronically delivers test items related to the conceptual item of information to the learner to test the learner's understanding of the conceptual item of information, wherein delivery of the test items is over a spaced interval of time;
a recording module to which the learner provides answers to the test items and the answers are electronically recorded;
a feedback module that provides correct answers to the test items to the learner to foster learning about the conceptual item of information;
a calculation module that calculates a new level of difficulty, a new delivery interval, and a new content area for a subsequent test item based upon the electronically recorded answers; and
a retesting module that retests the learner based on the calculation of the new level of difficulty, the new delivery interval, and the new content area for a subsequent test item.

22. The system of claim 21 further comprising:
a curriculum creation module for creating a set of curricular objectives;
a development module for developing a set of educational elements that teach the set of curricular objectives, wherein the educational elements include conceptual items of information; and
a test item construction module for constructing test items to be delivered electronically to the learner, whereby the test items demonstrate proficiency of the conceptual items of information.

23. The system of claim 21, wherein the calculation module includes a spacing-based determination device to calculate a spacing-based factor of the new delivery interval, whereby the new delivery interval for delivery of a subsequent test item is increased for test items that have been answered correctly and the new delivery interval for delivery of a subsequent test item is decreased for test items that have been answered incorrectly.

24. The system of claim 21, wherein the calculation module includes a difficulty-based determination device to calculate a difficulty-based factor of the new level of difficulty, whereby the new level of difficulty of a subsequent test item is increased for test items that have been answered correctly and the new level of difficulty of a subsequent test item is decreased for test items that have been answered incorrectly.

25. The system of claim 21, wherein the calculation module includes a content-area determination device to calculate a content area-based proficiency factor of the new content area, whereby the new content area is accessed using the subsequent test item when the learner meets a pre-established content area-based proficiency factor.

26. The system of claim 21, wherein the test item delivery module provides educational material regarding the conceptual item of information to the learner to further foster learning about the conceptual item.

27. The system of claim 21, wherein the retesting module is operatively connected to the test item delivery module to electronically deliver an additional test item to the learner, and wherein the retesting module continues to deliver additional test items to the learner until the learner's understanding of the conceptual item of information reaches a pre-established level of proficiency.

28. The system of claim 24, wherein the calculation module determines the learner's understanding of the conceptual item of information including a learner's ability to retain knowledge of the conceptual item of information.

29. The system of claim 21, wherein the test item delivery module includes an electronic mail device to electronically deliver the test item to the learner by electronic mail.

30. The system of claim 29, wherein the electronic mail device delivers a hyperlink to enable access to a web-page where the learner provides an answer to the test item.

31. The system of claim 21, wherein the calculation module is included in a central server.

32. The system of claim 21, wherein the recording module receives the learner's electronically recorded answer provided in at least one format including short answer, multiple choice, matching, identification of an element in a picture, identification of an element in a video, or identification of an element in an audio recording.

33. The system of claim 21 further comprising an electronic recording device, wherein the test item requires the learner to demonstrate a skill and the learner's electronically recorded answer is measured by the electronic recording device to determine a level of proficiency at which the learner performs the skill.

34. The system of claim 21 further comprising an electronic receiving module, wherein the test item delivery module delivers the test item to the electronic receiving module.

35. The system of claim 34, wherein the electronic receiving module comprises at least one of a computer, a portable media device, a personal digital assistant, or a mobile email receiver.

36. The system of claim 21, further comprising delivering subsequent test items to the learner which pertain to a new content area when the learner meets a pre-established level of proficiency in a given content area.

37. The system of claim 21, wherein the test item delivery module includes a temporal spacing device, wherein the test item delivered to the learner is adapted to the learning needs of the learner using temporal spacing, whereby a learner with a lower baseline knowledge level in a content area receives a subsequent test item more frequently than a learner having a higher baseline knowledge level in the same content area.

38. The system of claim 35, wherein the calculation module and the electronic receiving module are included in a single physical device.

39. The system of claim 35, wherein the test items and the electronic receiving module are included in a single physical device.

40. The system of claim 26, wherein the educational material is included in a learner's electronic device.

41. The method of claim 1, wherein the calculated new level of difficulty, the calculated new delivery interval, and the calculated new content area for a subsequent test item are unchanged so that the subsequent test item is of the same level of difficulty, delivered at the same delivery interval, and pertains to the same content area as an initial test item.

42. The method of claim 1, wherein the calculating step includes the determination of a change to at least one of the calculated new level of difficulty, the calculated new delivery interval, and the calculated new content area for the subsequent test.

43. The method of claim 1, wherein the calculating step includes the determination of a change to only the calculated new delivery interval for the subsequent test item such that spacing between delivery of the test items is changed.

44. The system of claim 21, wherein the calculated new level of difficulty, the calculated new delivery interval, and the calculated new content area for a subsequent test item are unchanged so that the subsequent test item is of the same level of difficulty, delivered at the same delivery interval, and pertains to the same content area as an initial test item.

45. The system of claim 21, wherein the calculation module determines a change to at least one of the calculated new level of difficulty, the calculated new delivery interval, and the calculated new content area for the subsequent test item.

46. The system of claim 21, wherein the calculation module determines a change to only the calculated new delivery interval for the subsequent test item such that spacing between delivery of the test items is changed.
